(19) United States
(12) Patent Application Publication
(10) Pub. No.: US 2019/0104691 A1
(43) Pub. Date: Apr. 11, 2019

(54) HORTICULTURE DEVICE AND METHOD

(71) Applicant: John Momcilovich, Attica, MI (US)

(72) Inventor: John Momcilovich, Attica, MI (US)

(21) Appl. No.: 16/214,095

(22) Filed: Dec. 9, 2018

Related U.S. Application Data
(63) Continuation-in-part of application No. PCT/US17/37450, filed on Jun. 14, 2017.
(60) Provisional application No. 62/350,234, filed on Jun. 15, 2016.

(51) Int. Cl. A01G 13/02; A01G 29/00

(52) U.S. Cl. CPC A01G 13/0281; A01G 9/28; A01G 29/00

(57) ABSTRACT

A pan-like shaped device with at least one opening in the bottom to accommodate a plant stem or trunk, having at least one aperture in the bottom to permit water to escape to the plant roots and interlocking peripheral walls extending upward from the perimeter of the bottom of the device so the device can be easily connected with like devices having interlocking peripheral walls to expand the area encompassed by the devices. When placed around a growing plant, the horticulture device provides a basin for directing water to the roots of a plant, helps to control weeds because it acts as a weed barrier, and retains moisture around the root by slowing evaporation. The horticulture device can be made in various sizes and shapes to accommodate various kinds of plants and ground areas and various connectors can secure multiple devices together to cover a greater ground area.

### CROSS REFERENCE TO RELATED APPLICATIONS

The present application claims the benefit of U.S. Provisional Patent Application Ser. No. 62/350,234 entitled HORTICULTURE DEVICE AND METHOD, filed on Jun. 15, 2016, the entire contents of which are incorporated by reference; and PCT application Serial No. PCT/US20170/37450, filed Jun. 14, 2017.

### FIELD OF THE INVENTION

This invention relates to horticulture devices that can be used to water and protect growing plants singularly or multiple plants grown in rows or randomly.

### BACKGROUND INFORMATION

It is important for plant growth that sufficient water can be directed to the root systems. Watering systems assist nature in this respect by periodically supply water over generalized ground area leading to waste. It is more effective and efficient to focus water to the root area thus conserving water. U.S. Pat. No. 3,005,287 to Dudley, GB 2,370,482 to Cooper, U.S. Pat. No. 2,822,644 to Berger, and U.S. Pat. No. 5,918,411 to Hadrava all disclose circular pans with central openings through which a plant can grow, with a surrounding circular channel or channels for holding water. The base of the channels in '287 and GB '482 include openings into watering spikes which allow water in the channels to drain down into the ground around the plant roots. “411 and '644 include openings in the base of their channels which allow water in the channels to drain onto the ground.

### SUMMARY OF THE INVENTION

The present invention comprises a horticultural watering device and a method of employing multiple such devices to encompass multiple plants and a large area of ground. Each device comprises a pan having a front, back and side walls with at least one opening in the bottom to accommodate a plant stem or trunk and having at least one aperture in the bottom to permit water in the pan to escape to the plant roots. The pan has at least two interlocking perimeter walls extending upward from the bottom perimeter of the device so the device can be easily connected with like devices having mating interlocking perimeter walls to expand the area encompassed by the devices. When placed around a growing plant the horticulture device provides basins for directing water to the roots of a plant, helps to control weeds because it acts as a weed barrier, and retains moisture around the root by slowing evaporation. The horticulture device can be made in various sizes and shapes to accommodate various kinds of plants and ground areas and various interlocking connectors can secure multiple devices together to cover larger areas of ground.

These and other features, objects and advantages of the horticulture device will be more fully understood and appreciated by reference to the description of the preferred embodiments, and the appended drawings.

### DESCRIPTION OF THE DRAWINGS

FIG. 1 is a view in perspective of one embodiment of the invention;

FIG. 2 is a corner to corner cross section, taken along plane II-II of FIG. 1 showing the slopes of the depressions and the use of using watering spikes;

FIG. 3 shows another embodiment of the invention which includes connector flanges and interlocking connectors on the flanges:

FIG. 3A is a fragmentary cross-sectional view of connector flanges with identical projections on each flange, which interconnect with a snap fit when their flanges are overlapped;

FIG. 3B is a fragmentary cross-sectional view of another embodiment, in which alternative interlocking connector flanges are located at the top of each perimeter wall;

FIG. 4 shows another embodiment of the invention wherein the device is spilt into two pieces to be assembled and locked together around a plant stem or trunk;

FIG. 5 shows a view of six devices assembled together;

FIG. 6 shows an embodiment of the device including several stem holes that are elongated into a row to accept rows of plant stems;

FIGS. 7 and 8 show an embodiment of the invention wherein clips are used on the perimeter walls as interlocking connectors;

FIG. 9 is a perspective view of an alternative device in which four individual stem holes are arranged in a single pan;

FIG. 10 is a perspective view of an alternative device in which five individual stem holes are arranged in a single pan;

FIG. 11 is a perspective view of the device and an associated planter, wherein the device and planter can be separated to facilitate filling the planter, but joined together for planting and watering;

FIG. 12 is a perspective see through and partial cross section view of a five gallon pail used as planter, with a round horticulture device of the preferred embodiments positioned in it;

FIG. 13 is a top perspective view of the round device of FIG. 12;

FIG. 14 is a bottom perspective view of the device of FIG. 12;

FIG. 15 is a perspective view of a pair of devices joined together by a hook in slot connector; and

FIG. 16 is a fragmentary cross section showing the hook in slot connection.

In the drawings and description, the following numbers refer to:
10—horticulture device
10a—round horticultural device
11—pan-like structure
12—bottom
12a—radial depressions
13—perimeter walls
13a—stand offs on round wall 13 of round device 10a
14—watering aperture
14a—threaded spike fitting
15, 15a and 15b—interlocking connectors, 15a being a male connector and 15a being a female connector
15c—alternative embodiment interlocking connectors
16—watering spike
17—plant stem or trunk hole
17a—elongated openings for planting rows of plants or seeds
18—plant stem or trunk
19—roots
20—perimeter flanges extending perpendicularly from perimeter walls 13
20a—alternative embodiment perimeter flanges.
21—interior wall extending upward from perimeter of 17
21b—interior walls extending upward from the perimeter of elongated openings 17a.
24—clip interlocking connectors
25—water in device.
26—surface of the ground.
40—split horticulture device
41a, 41b—identical half pan-like structures
42a, 42b—bottoms of pan-like structures
43a, 43b—perimeter walls
44a, 44b—watering apertures
45, 45a, 45b—interlocking connectors, 45a being a male connector and 45b being a female connector
46a, 46b—interior perimeter interlocking walls
47—plant stem or trunk hole
48a, 48b—interior walls extending up from 47.
70—clips
71—hook connectors
72—hook receiving slots
80—planter
81—upper edge or flange
82—connectors
90—five gallon pail planter

### DESCRIPTION OF THE PREFERRED EMBODIMENT

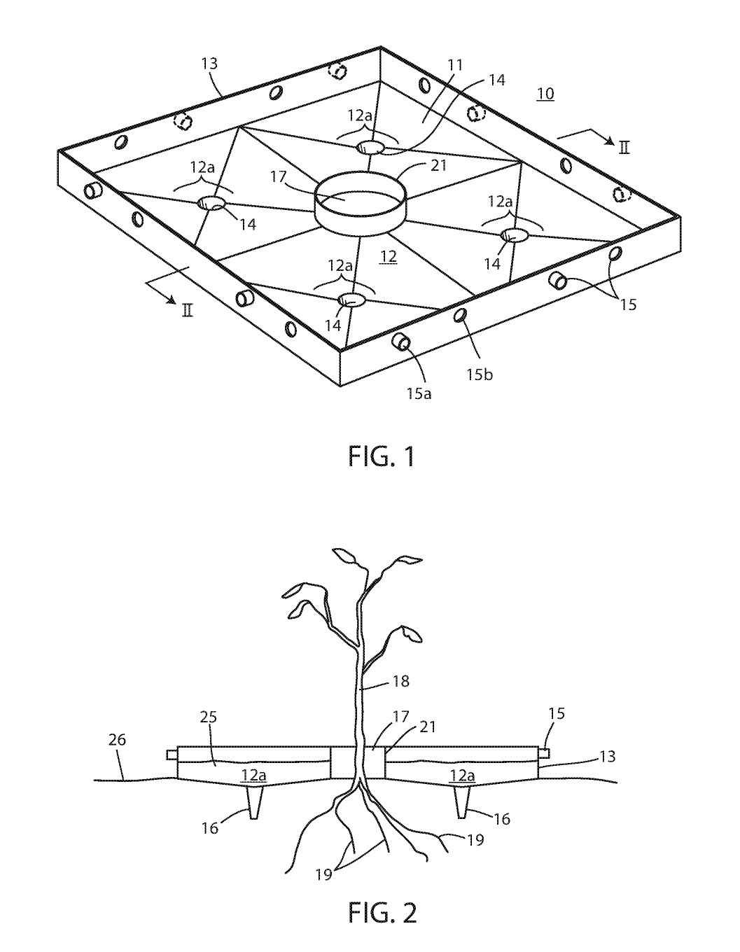

In the preferred embodiments, each horticultural watering device 10 comprises a pan 11 having perimeter walls 13, a bottom 12 with a central opening 17 to accommodate a plant stem or trunk, surrounded by an upstanding interior wall 21 (FIG. 1). Multiple depressions 12a in the bottom 12 of said pan 11, are oriented radially around and slope downwardly away from the base of interior wall 21 and said center opening 17, and slant downwardly from each perimeter wall 13. The slanted portions meet at a level below the lower edge of said perimeter walls 13 to form a trough with said trough defining a watering aperture at the lowest point of each depression 12a.

A watering aperture 14 is located at the low point of each depression 12a to permit water in pan 11 to escape into the ground, or into a watering spike 16 associated with each aperture 14, and then into the ground as shown in FIG. 2 and described below. The pan 11 has interlocking perimeter walls 13 extending upward from the perimeter of the device so the device can be easily connected with like devices having mating perimeter walls to expand the area encompassed by the devices. In the preferred embodiment, the perimeter walls 13 are linear, and the pan is polygonal in configuration, which helps facilitate the interconnection between multiple devices via male and female connectors 15a and 15b. This facilitates covering and preventing evaporation from large areas of ground and servicing multiple plants at a time and not leaving ground between plants uncovered. Regular polygonal shapes are preferred such as squares, equilateral triangles and the like. Rectangles, hexagons and the like can also be used.

FIG. 2 illustrates a cross section of the embodiment in FIG. 1 that includes a watering spike 16 associated with each aperture 14, to deliver water deeper into the growing medium. The watering spike comprises a hollow tube with dispersing apertures that permit water collected in the device to be dispersed below the surface of the ground and closer to the roots of a plant 19. The watering spike can be formed as part of pan 11 or can be separate therefrom and one or more pushed through, or attached to, one or more watering holes 14. The watering spikes also stabilize the device against movement when placed of the surface of the ground.

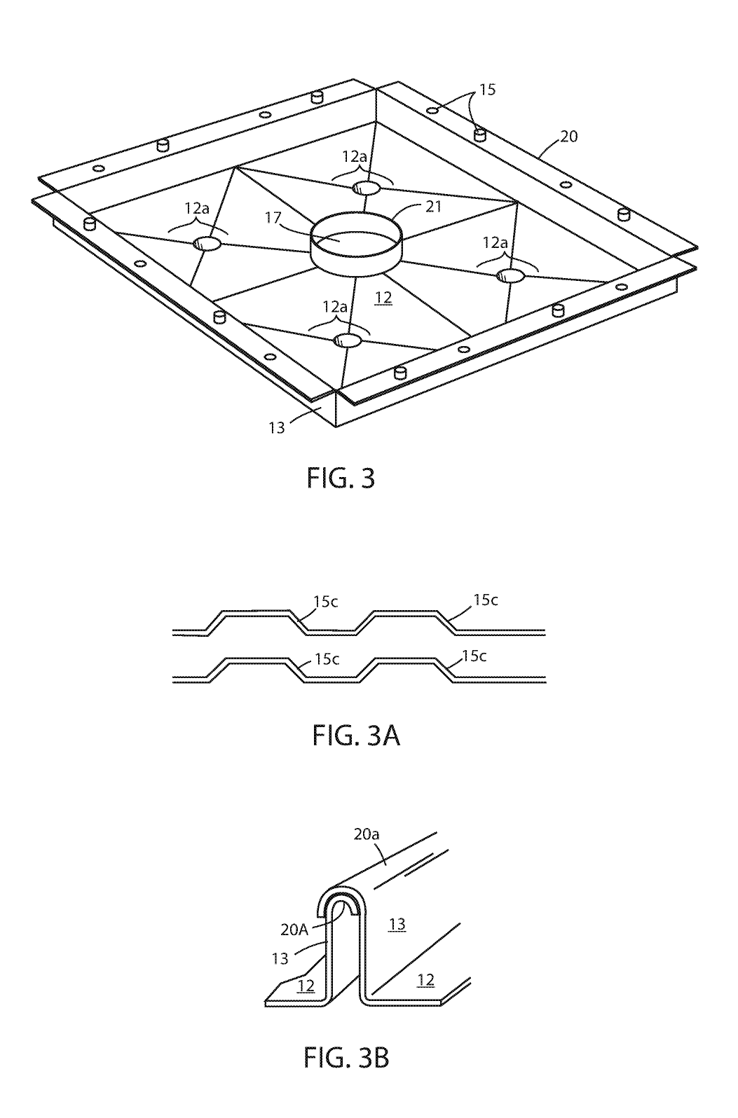

FIG. 3 illustrates another embodiment of horticulture device 10. The device is similar to that illustrated in FIG. 1 and includes in addition perimeter flanges 20 attached to and extending perpendicularly outward from the perimeter walls 13. The flanges define interlocking mating male and female connectors, 15a and 15b as described for FIG. 1 and positioned around the flanges so multiple horticulture devices 10 can be connected, flange 20 to flange 20.

FIG. 3A shows alternative interlocking members 15c, which are all identical. Each connector is a projection formed in perimeter flange 20, to define a depression on one side of the flange and a projection on the other side. When flanges 20 are overlapped, the projections 15c on one flange 20 extend into the depressions formed by the projections 15c on the other flange. The projections are formed to provide a snap fit between mating projections 15c. In FIG. 3B, each perimeter wall 13 of device 10 includes an inverted “U” shaped connector flange 20a at its upper edge. By making devices 10 of a somewhat flexible thin walled material, flanges 20a can all be of the same configuration, yet will nest and interlock when one is fitted over an adjacent flange 20a. This can be accomplished by forming devised 10 of a plastic which is intermediate in flexibility between the typical trays in which plantings are sold, and the pots in which plants are sold.

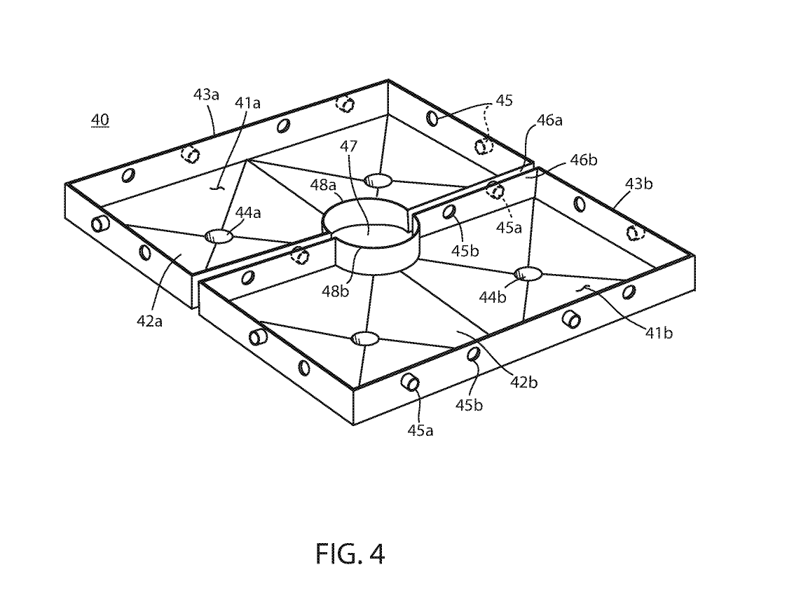

The horticulture device 10 embodiment in FIG. 4 is identical to that of FIG. 1 except is prepared in two sections each of which is identical to the other. The device includes two half pan structures 41a and 41b, bottoms 42a and 42b. The device has perimeter walls 43a and 43b which connect with interior perimeter walls 46a and 46b to form two pans. The two interior walls define interlocking male and female connectors 45a and 45b. Similar male and female connectors 45a and 45b are located in the exterior perimeter walls 43a and 43b, (FIG. 4). The bottom defines watering apertures 44a and 44b. A plant stem or trunk hole 47 is provided when the two pan-like structures 41a and 41b are locked together using the interlocking interior perimeter walls 46a and 46b. The device includes interior walls 48a and 48b extending up from the perimeter of the plant stem or trunk hole 47 which mate at their vertical edges when the two pan-like structures are interlocked together. This embodiment permits the device to be used with established plants such as trees, bushes and the like.

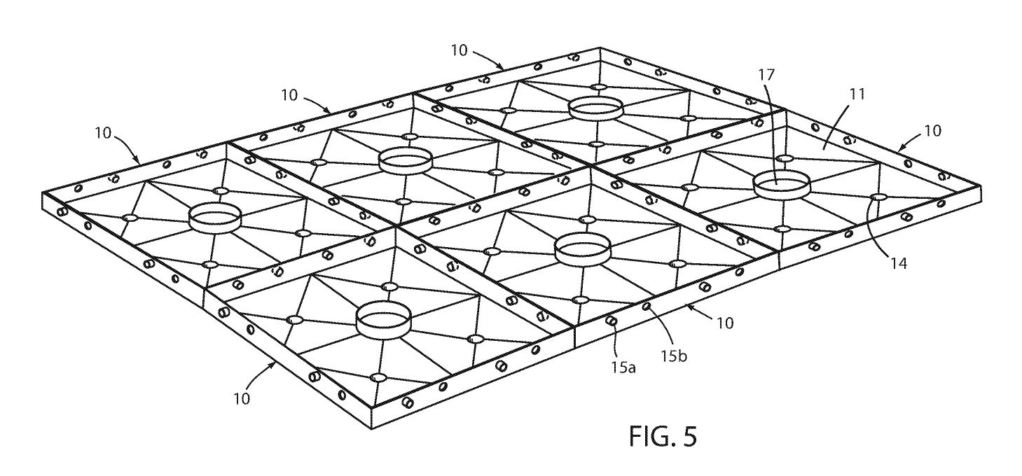

The interlocking connectors comprise male and female elements 15a and 15b that are positioned so two or more devices 10 may be connected as shown in FIG. 5. In this embodiment the position of the interlocking connectors 15a and 15b is such that when looking at the front side of a perimeter wall 13, a female connection 15b (in the drawing a hole) is provided further to the right with a male cylindrical connector 15a extending outwardly from the perimeter wall 13 to the left of the female connector. Further to the left on the perimeter wall are provided another set of female/male interlocking connectors. This pattern of male female interlocking connectors is repeated on each of the perimeter walls such that on opposite walls of the device a male cylindrical connector is positioned directly opposite to the female connector on the opposite wall. This arrangement of interlocking connectors permits devices 10 to be interconnected with each other at the perimeter walls as shown in FIG. 5. In these embodiments the female interlocking connector is shown as a hole. If a hole is the female interlocking connector it is preferred that it be located near the top of the perimeter walls so that the maximum amount of water can be placed in the device 10 without leaking off when a single device is being used. If desired and preferably the female interlocking connector comprises a closed cylindrical element. With this arrangement the male interlocking connectors on the perimeter wall of a first device 10 will engage with the female interlocking connectors on the perimeter wall of a second device and the female interlocking connectors on the perimeter wall of the first device will engage with the male interlocking connector on the perimeter wall of the second device 10. The female and male interlocking connectors are sized so friction between them when engaged with each other will hold the devices together. The devices may be separated by providing force to the female male connections.

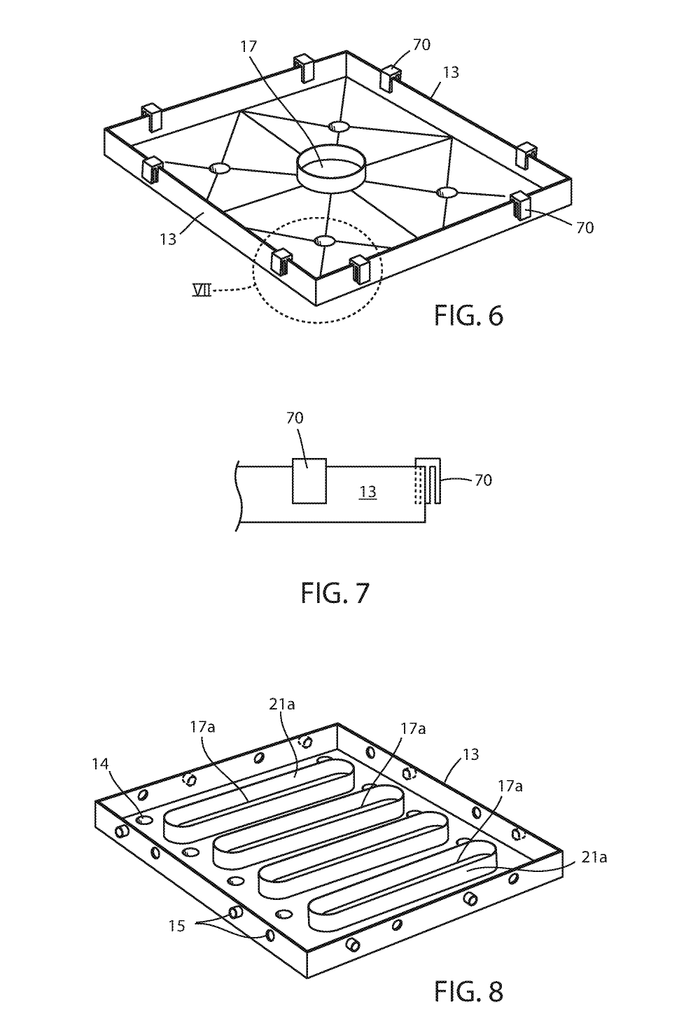

Another embodiment of connectors 70 are shown in FIGS. 6 and 7. In this embodiment the interlocking connectors are clips 70 arranged around the outside perimeter walls 13 in a manner so that like devices 10 can be interconnected with each other. The clips should be staggered across from each other and preferably used on each wall. Clips 70 can also be used instead of interlocking connectors 15a and b, or 15c, in the devices 10 shown in FIGS. 1, 4 and 5.

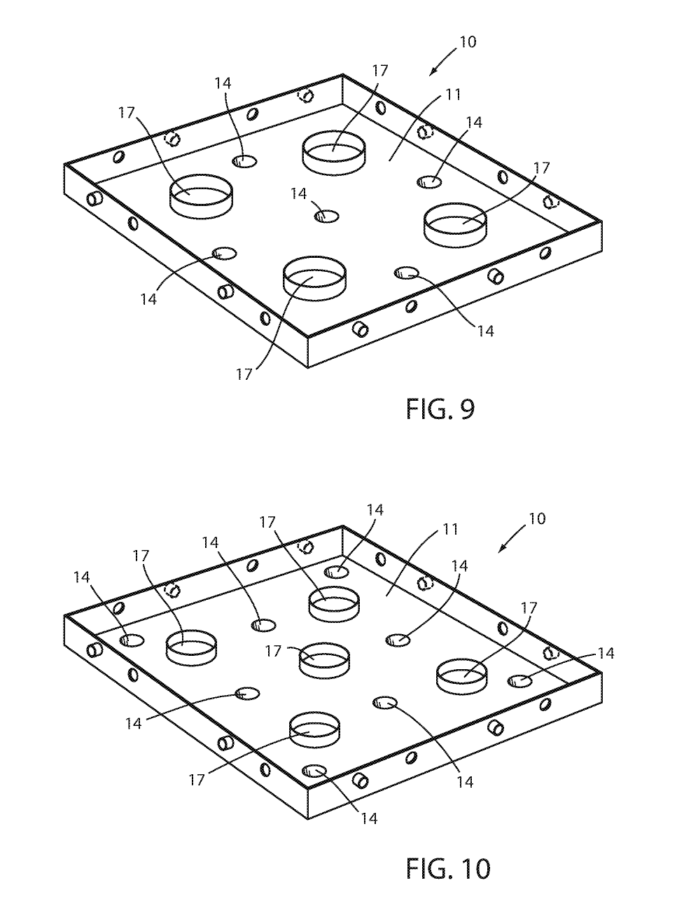

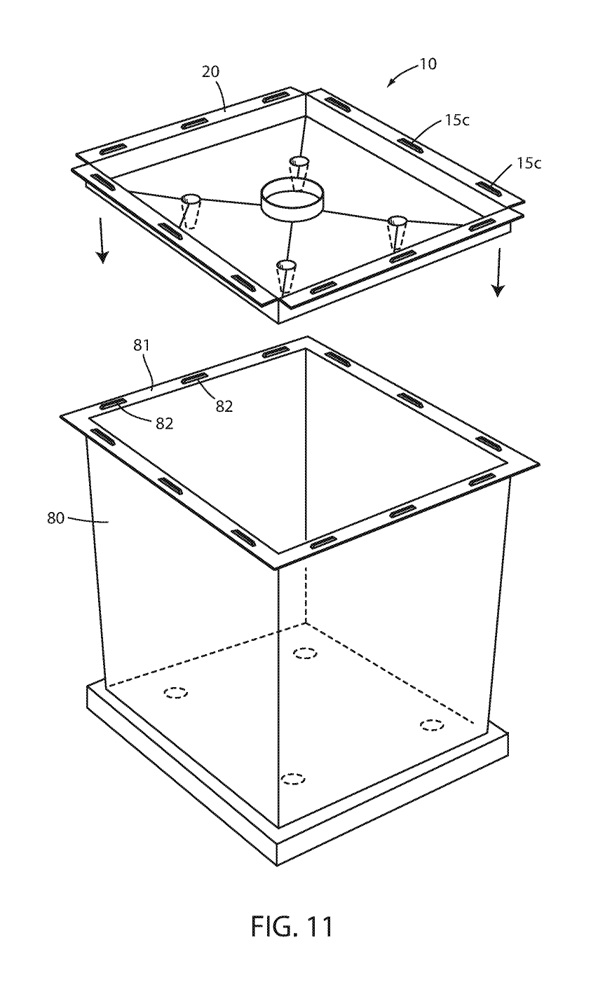

FIG. 8 illustrates another embodiment where multiple elongated openings 17a in the bottom 12 of pan 11 are provided, to accompany plants that are planted in rows such as carrots, and the like. Openings 17a are surrounded by upstanding interior walls 21a. FIGS. 9 and 10 show alternative devices having multiple plant openings 17 in the bottom 12 of pan 11. In FIG. 9, four plant openings 17 are provided in a square or rectangular pattern. In FIG. 10, five plant openings 17 are provided, four in a square pattern and one in the center of pan 11.

FIG. 11 shows a planter 80 having an upper perimeter flange or edge 81, which includes connector depressions 82 therein. A matching and mating watering device 10 is provided having a connector flange 20 with connector projections 15c therein, which mate with connector depressions 82. The combination of planter 80 and device 10 can be sold together. Planter 80 can be filled with garden medium when device 10 is separated from planter 80. Device 10 can then be connected to planter 80 by snapping connectors 15c into depressions 82. Plants or seeds can then be planted in the plant opening or openings 17 and watered and cared for in the normal manner. Of course, it will be appreciated that various connector systems could be employed, and other embodiments of device 10 could be employed in conjunction with planter 80.

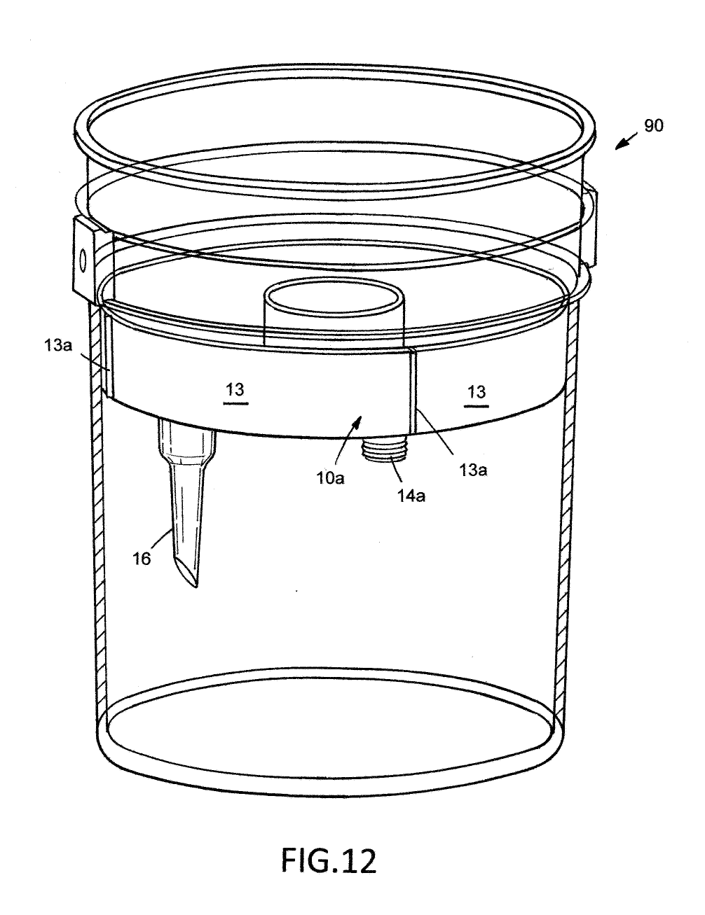

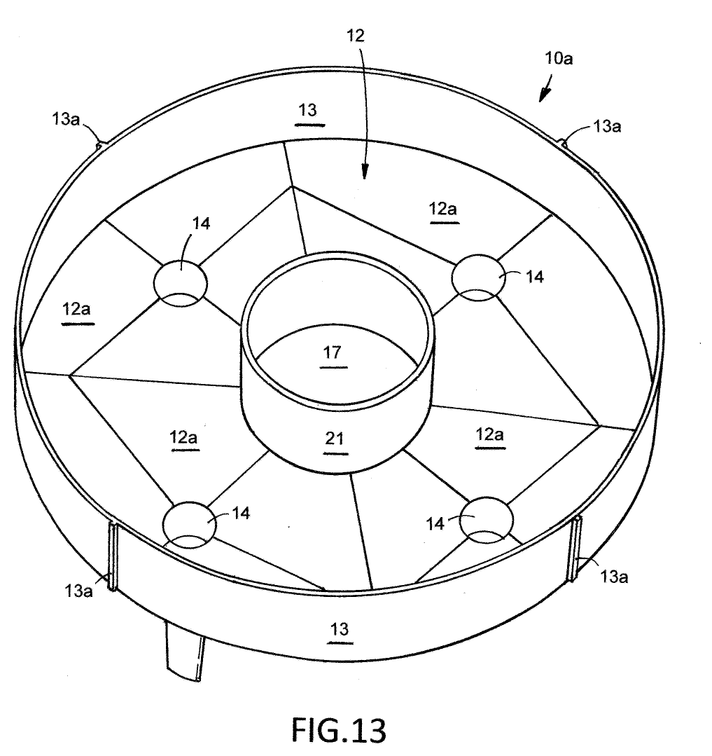

FIG. 12 is a perspective see through and partial cross section view of a five gallon pail 90 used as planter, with an alternative round horticulture device 10a positioned in it. Device 10a has a circular perimeter wall 13 which is of a radius which allows it to just fit inside of and down into pail 90 a short distance. At least four stand-off ribs 13a project outwardly from the exterior of said perimeter wall 13, such that device 10a can be slid up or down more easily inside of pail 90 (FIGS. 12, 13 and 14). Ribs 13a are dimensioned to press against the inside wall of pail 90, forming a space between the rest of the pail wall and the outside of said perimeter wall 13.

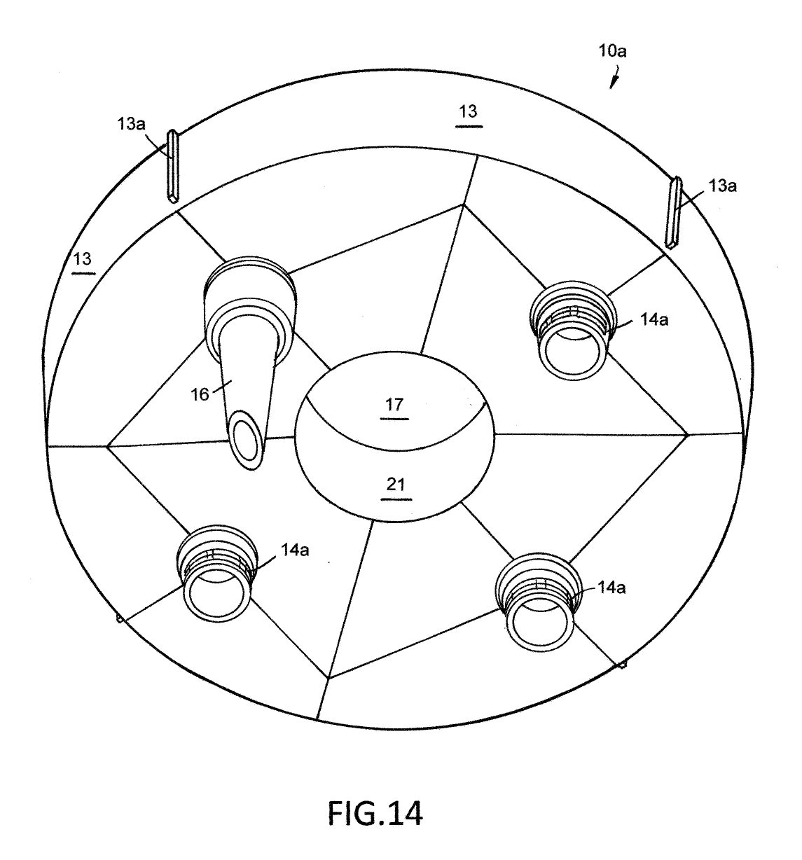

Device 10a includes a central opening 17 through which a plant stem or stems can pass (FIG. 13). An interior circumferential wall 21 projects upwardly from the perimeter of opening 17. Depressions 12a in the bottom wall 12 of device 10a slope downwardly towards the watering openings 14. Openings 14 open into threaded fittings 14a to which watering spikes 16 can be threaded (FIGS. 12 and 14).

In use, a five gallon pail is filled with dirt and plant nourishments to a desired depth. Device 10a is inserted and pressed down to sit on top of the dirt. Seeds or a plant or sapling is planted in the dirt below opening 17 and surrounding interior wall 21. Water is added periodically to device 10a, which flows down into the dirt through openings 14 and spikes 16. As with the other devices of the preferred embodiment, bottom 12 of device 10a reduces evaporation loss of the nourishing water, and the plants or small trees grow up through opening 17 and surrounding wall 21.

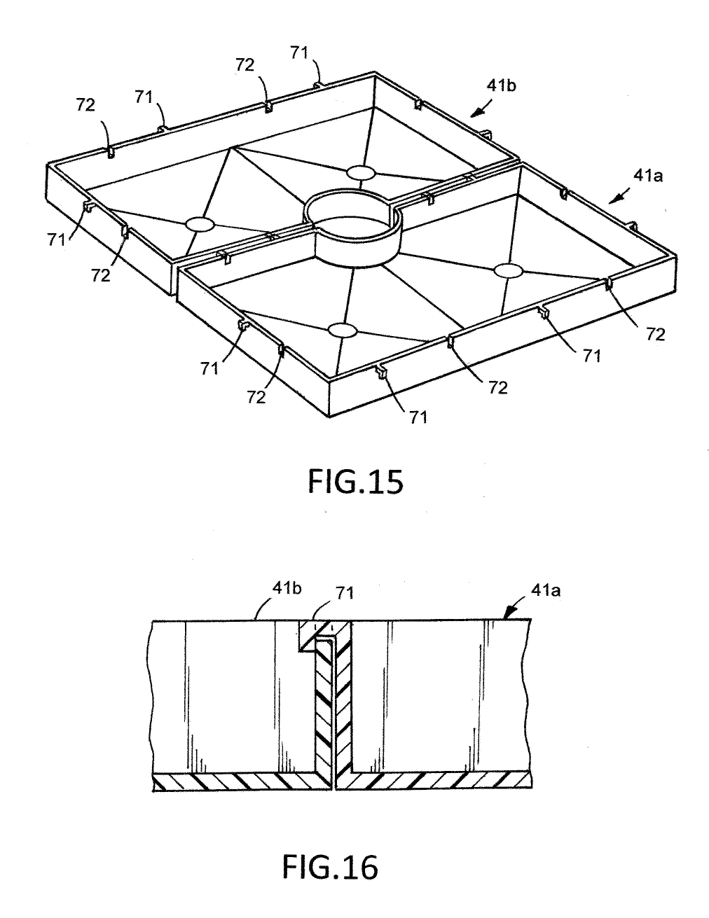

FIGS. 15 and 16 illustrate a hook 71 and slot 72 connector system for connecting adjacent horticultural devices together. The split device 40, having parts 41a and 41b is used to illustrate the system, but it could be used to connect other types of preferred embodiment devices, e.g. devices 10 as shown in FIG. 5. Alternating hooks 71 and slots 72 are provided along the perimeter walls 13, and are arranged in opposite adjacency on opposite walls, so that the hooks 71 on one device will slide into the slots 72 of the next adjacent device, to connect the two devices together.

The devices can be constructed from moldable plastics, formable sheet metals, water proofed pressed paper products and the like. It is optional to provide the devices in different colors for decorative or climate purposes. In cooler zones dark colors may be preferred to absorb sun's rays and warm the water and earth. In hotter zones it may be preferred to use lighter colors to prevent excess heating of the water and ground.

The devices can be made in different sizes. In the embodiments shown in the drawings and in the following Example each device 10 measured 24 by 24 inches wide and the perimeter walls 13 were 2 inches high. The watering spikes were six inches long. The stem hole 17 was six inches in diameter and the wall 21 extending upwardly from the hole was two inches high. The watering holes 17 were one and one-half inches in diameter. The flanges extending from the perimeter walls 13 (FIGS. 3A & 3B) were one inch wide. Of course, much larger devices 10, 10a or 40 can be provided for use in different agricultural applications. Similarly, spikes of varying depths may be used in the same device, as for example putting 6-inch spikes near an opening 17, and 18-inch spikes nearer the perimeter walls 13.

### EXAMPLE

Tomato plants were grown during a normal growth season. The plants were purchased at a local retail store. Two large and two smaller plants were used in the Example. One of the smaller plants and one of the larger plants were grown in common ground soil using two devices as described in the previous paragraph with the plants extending through the center hole 17. The other large and small plants were planted in the same garden bed about three feet from the plants that were planted using the device. Watering started on the first day of planting and periodically continued through a growing season of 74 days when the tomatoes were harvested. All the plants were initially watered with 2 quarts of water every other day (except days when it rained.) During the warmer months the two plants in the devices were continued to be watered with two quarts of water (the limit of the devices while the two plants not having the devices were watered with 3 or four quarts of water because of the dry soil conditions. Again, no watering was done on days that it rained. The tomatoes were harvested. Plant number 1 with device 10 produced 45 tomatoes; Plant number two with the device 10 produced 42 tomatoes; Plant number 3, grown without the device 10 produced 28 tomatoes. Examination of the root systems showed that plant number 3, grown without device 10 grew toward plant number 2 having the device 10, indicating plant number 3's tendency to seek the moisture under plant number 2. No weeding was required for plants number 1 and number 2 which were grown using the devices while plant number 3 had to be weeded approximately once per week. Based on the recorded watering amounts the tomato plants using the devices 10 required about 28 percent less water than the plant set directly in the ground without the device 10. The plants grown using the device 10 produced approximately 50 percent more tomatoes.

Of course, it is understood that the forgoing are preferred embodiments of the invention, and that various changes and modifications can be made without departing from the scope and spirit of the invention.

What is claimed is:

1. A horticulture watering device, comprising:
a pan-like structure;
a bottom;
at least one plant opening in the bottom to accommodate a plant stem or trunk;
at least one watering aperture in the bottom to permit water to escape to the plant roots; and perimeter walls extending upward from the perimeter of said bottom of said device; each said perimeter wall having at least one connector enabling said device to connect with at least one other of said devices to expand the area encompassed by the devices.

2. The horticulture device of claim 1 wherein an interior wall extends upwardly from the edge of said plant opening.

3. The horticulture device of claim 1 wherein said interlocking perimeter walls comprise:
perimeter walls having at least one female interlocking connector and at least one male interlocking cylinder extending therefrom.

4. The horticulture device of claim 1 wherein said interlocking perimeter walls comprise:
a flange extending outwardly from the top of each said interlocking perimeter wall, said flange interlocking with flanges on adjacent devices, to connect adjacent ones of said interlocking walls.

5. The horticulture device of claim 1 wherein said interlocking perimeter walls comprise:
spaced hooks extending outwardly from the top of each said interlocking perimeter wall, and intervening slots between said hooks; said hooks and slots being alternatively spaced on opposite walls, such that said hooks engage said slots on adjacent devices, to connect adjacent ones of said interlocking walls of adjacent devices.

6. The horticulture device of claim 1 wherein said bottom of the device slants downwardly from each said perimeter wall to said watering aperture, and downwardly from said plant opening to said watering aperture, whereby said downwardly sloping walls form a trough with said watering aperture being located at the lowest point of said trough.

7. The device of claim 6 in which: said watering apertures open into fittings to which watering spikes are connected.

8. A horticulture device comprising two sections each section comprising a bottom and side walls extending upwardly from the perimeter of said bottom; at least one connector side wall in each said section having interlocking connectors which join said connector side walls; each of said connector sidewalls deviating away from each other for a distance sufficient to form a plant opening between said sections; said bottom of each said section defining at least one aperture to permit water collecting in said device to escape to the ground.

9. A horticultural device and planter combination comprising: said horticultural device having a pan-like structure with a bottom; at least one plant opening in said bottom to accommodate a plant stem or trunk, at least one aperture in said bottom to permit water to escape to the plant roots, and exterior perimeter walls extending upward from the perimeter of said bottom of said device; said planter comprising a container having a bottom, upstanding perimeter walls and an open top; said planter being configured to receive said horticultural device in said open top, and said planter perimeter walls and said horticultural device perimeter walls including mating features which facilitate releasable mating of said horticultural device in said open the top of said planter.

10. A horticultural device and planter combination comprising: a planter comprising a cylindrical pail having a bottom and a side wall;
a round horticulture device positioned for positioning in said pail; said device including an exterior perimeter wall and a bottom wall; said bottom wall having a plant stem opening therein through which a plant stem or stems can pass; an interior wall projecting upwardly from the perimeter of said plant stem opening; said bottom wall including a plurality of watering openings therein, spaced around said plant stem opening; said bottom wall sloping downwardly from said exterior perimeter wall and said internal wall towards said watering openings.

11. The horticultural device and planter combination of claim 9 in which: said exterior perimeter wall is dimensioned so as to fit inside of and down into said pail a desired distance; a plurality of stand-off ribs are spaced around and project outwardly from said exterior of said exterior perimeter wall and abut said pail side wall leaving a space between said pail side wall and said exterior of said perimeter wall of said device, whereby said device can be slid up or down more easily inside of pail.

12. The horticultural device and planter combination of claim 11 in which: said watering openings open into fittings to which watering spikes are connected.

13. The horticultural device and planter combination of claim 10 in which: said watering openings open into fittings to which watering spikes are connected.

14. A method of growing plants which comprises: providing a horticultural device having a bottom, at least one plant opening in said bottom to accommodate a plant stem or trunk and at least one watering aperture in said bottom to permit water to escape to the plant roots, and perimeter walls extending upward from the perimeter of said bottom of said device; placing said horticultural device on dirt in which plants are to be planted, and planting a plant or plants in said plant opening whereby the stem or trunk of the plant grows through said plant opening defined; watering said plant by pouring water into said device and letting it flow into the dirt beneath said device, said bottom of said device minimizing the evaporation of water from the dirt below said device.

15. The method of claim 14 wherein a plurality of said horticultural devices are provided, each having perimeter walls having at least one connector connecting each said device to at least one other of said devices to expand the area encompassed by said horticultural devices; growing at least one of multiple plants through each said plant opening in each of said connected horticultural devices.

16. A method of growing plants which comprises: providing a planter having a bottom, a perimeter side wall or side walls and an open top; providing a horticultural device having a bottom, at least one plant opening in said bottom to accommodate a plant stem or trunk and at least one watering aperture in said bottom to permit water to escape to the plant roots, and perimeter walls extending upward from the perimeter of said bottom of said device, said bottom wall sloping downwardly from said exterior perimeter wall and said internal wall towards said watering openings; placing dirt in said planter; joining said horticultural device to said planter above said dirt in said planter, and planting a plant or plants in said plant opening whereby the stem or trunk of the plant grows through said plant opening defined; watering said plant by pouring water into said device and letting it flow into the dirt beneath said device, said bottom of said device minimizing the evaporation of water from the dirt below said device.

17. The method of claim 16 in which said planter comprises a cylindrical pail having a bottom and a side wall; said horticultural device comprising a round horticulture device dimensioned to fit inside said cylindrical pail; placing dirt in said pail; positioning said device in said pail on top of said dirt.

18. The method of claim 17 comprising: said planter being configured to receive said horticultural device in said open top, and said planter perimeter walls and said horticultural device perimeter walls including mating features which facilitate releasable mating of said horticultural device in said open the top of said planter.
